(19) United States
(12) Patent Application Publication
(10) Pub. No.: US 2012/0177349 A1
(43) Pub. Date: Jul. 12, 2012

(54) DEVICE PLACED INTO A SHOWER HEAD FOR RECOVERY OF ENERGY USED DURING A SHOWER

(76) Inventor: Geraldo Magela Carvalhais, Belo Horizon.MG Cep: (BR)

(21) Appl. No.: 13/383,393

(22) PCT Filed: Oct. 24, 2011
(86) PCT No.: PCT/BR11/00399

§ 371 Date: Jan. 10, 2012

(30) Foreign Application Priority Data
Oct. 22, 2010 (BR) P1 1004101-0
Jan. 14, 2011 (BR) MU020110004744
Oct. 24, 2011 (BR) PI014110003040

(51) Int. Cl. F28D 17/00; F24H 1/10

(52) U.S. Cl. 392/308; 165/10

(57) ABSTRACT

This patent refers to a new technological development that concerns the electric equipment industry, specifically for those dedicated to producing electric shower heads, earmarked to reduce the consumption of electrical energy by offering an energy efficiency of around 60%. The object of this patent is principally intended for electrical showers, for the above mentioned reasons, however, its inventive concept may be applied to gas shower heads, in the sector of boilers and industries that use heated water or steam in their production processes, faucets heated for hotels, restaurants, dry cleaners and others, and may also be used in large amounts of water, for example, for swimming pools and any other systems where the reuse of heat energy can be applied by recirculating water or heated steam. The design applied to the embodiments presented is based on the principal of water circulation in a closed circuit in appropriate chambers, placed contiguously with the shower head or inside it.

### FIELDS OF THIS PATENT

Water heating

Electric shower heads and faucets

Boilers and similar equipment

Reduced costs due to energy efficiency

This patent refers to a new technological development with regard to the electrical equipment industry, in particular those dedicated to the production of electric shower heads, designed to reduce consumption of electric energy by offering an energy efficiency on the order of 60%.

### STATE OF THE ART

In Brazil, electric shower heads are used by 90% of the population and its use occurs mostly between 06:00/08:00 AM and 6:00/8:00 PM. In this way, the concessionaires of electricity are obliged to satisfy this demand at a very high cost, and the shower is considered to be responsible in great part for low energy efficiency and higher costs of the distribution system for electric power in the country.

Whereas the cost and consumption of electric power has risen steadily over the last few decades, the search for alternative solutions is characterized as being one of the main priorities in the social and ecological aspect, and this solution is characterized as a “green technology”.

### CRITICISM OF THE STATE OF THE ART

With respect to electric shower heads in the current State of the Art, much has been done to improve their energy efficiency, such as timers that limit the time for a hot bath cutting off the electric current of the shower after a fixed time and only providing conditions for the current to flow after another fixed time period; shower heads with systems to reduce energy consumption, formed by louvers that restrict the flow of water coming from the external piping; box with a coil on its floor, that recovers heat through water heated while bathing, functioning as a pre-heating device for the water that feeds the shower head, avoiding in this way a greater expenditure of electric energy during the bath, being that the same water with which the shower head is taken, pre-heats the cold water that feeds the shower head, branching off afterwards, with one part of the water going to the shower head and the other part to the coil reservoir, and etc.

As an example of the known State of the Art, that describes a series of alternatives, mainly hot water/cold distributors in heating systems described in patent documents, we can cite: PI9805791-0, MU8401584-5, MU7402132-9, MU7402132-0, PI9804733-7, PI9302536-0, PI9805792-8, MU8500829-0, MU8700053-9, MU6301957-4, PI0504863-0, PI8506231-6, and PI9401081-1, which deal with specific equipment for certain situations, and most of which are complex and subject to operational and maintenance problems.

Some are electronically controlled and others have complicated systems of springs and valves and seek to distribute the water from one point where the hot and cold waters meet, coming from heaters and providing an input for the cold water coming from the network. Others are remote hot and cold water mixers to be used in shower heads and faucets or piping equipment containing a mixing chamber and provided with a cold water input, a hot water input, and a mixed water output. All of these proposing specific solutions to distribute hot water from one cold water source without, however, serving as a simple separate distribution of hot and cold water to direct or flow thereof from a cold water source.

The most important of the innovations known on the market, the so-called “box with a coil in the bottom” needs to be properly installed by a technician or, at the very least, by a person with some knowledge and hydraulic tools to create the external branch in the piping. All of this generates elements external to the original installation, which is certainly not very pleasing aesthetically.

When we look at the efficiency of such a product, we conclude that there is a great loss of heat energy considering that the heated water that comes out of the shower head, enters into contact with the air of the environment, and with the body of the user, losing in this course several degrees of temperature until it comes in contact with the coil on the bottom of the box that also creates a heat exchange. This all reduces its efficiency.

### INNOVATIONS TO THE STATE OF THE ART BY “SHOWER HEAD DEVICE TO RECOVER ENERGY USED DURING THE BATH”

The object of this patent is principally intended for electrical shower heads, for the above mentioned reasons, however, its inventive concept may be applied to gas shower heads, in the sector of boilers and industries that use heated water or steam in their production processes, faucets heated for hotels, restaurants, dry cleaners and others, and may also be used in large amounts of water, for example, for swimming pools and any other systems where the reuse of heat energy can be applied by recirculating water or heated steam.

### COMPARISON WITH THE STATE OF THE ART

Analyzing this innovation in comparison with the system that uses a similar concept is the reuse of heat energy that has already been produced, as in the case of the product described in the patent application PI 0003118-6, entitled “HEAT RECOVERY FOR HEATED SHOWER HEADS”, that uses a heat recoverer that is made up of a box with an hollow floor, that contains a heat exchanger inside that “covered by the hot bath water, it is transferred to the water supplying the shower head, since, before arriving at the heater, it passes through the heat exchange pipe”. We concluded that the object of this invention offers an energy efficiency that is very much higher that the aforementioned patent, as all heat exchange takes place within its own shower head and not in the environment, where several sources for losing heat energy exist.

### ILLUSTRATIONS AND DESCRIPTION OF THE “SHOWER HEAD DEVICE TO RECOVER ENERGY USED DURING THE BATH”

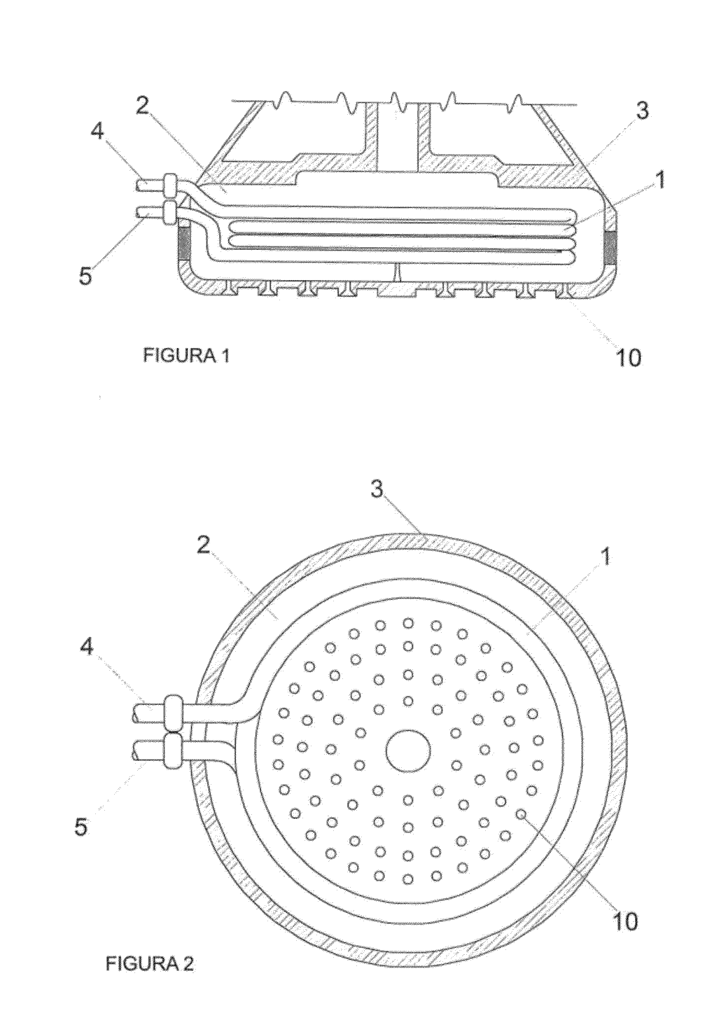

So that the design developed is perfectly understood, three preferred embodiments will be illustrated, all based on the same inventive concept, i.e., the use of a coil in a closed circuit for reuse of heat energy produced by electric heating element of the shower head or similar equipment, with a view to achieving high energy efficiency. The first embodiment is illustrated in FIGS. 1 to 3 and is accompanied by the description that follow:

FIG. 1 is an top view of a partial crosscut view of a shower head, showing the device inserted into the lower output chamber for the water.

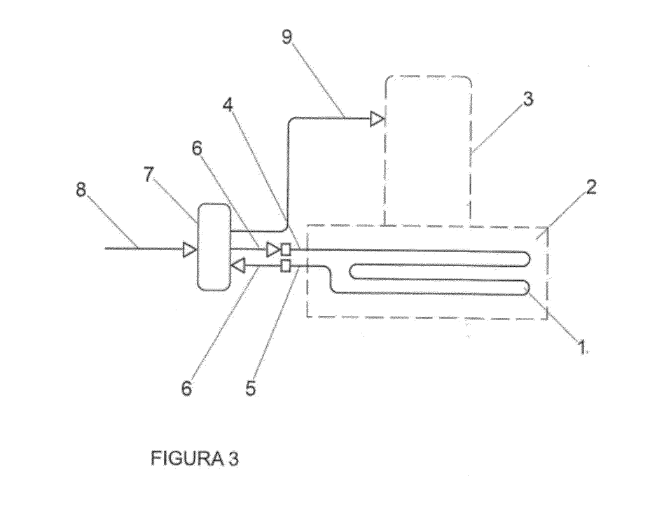

FIG. 2 is a cross cut view from the bottom of this chamber, showing the inserted device.

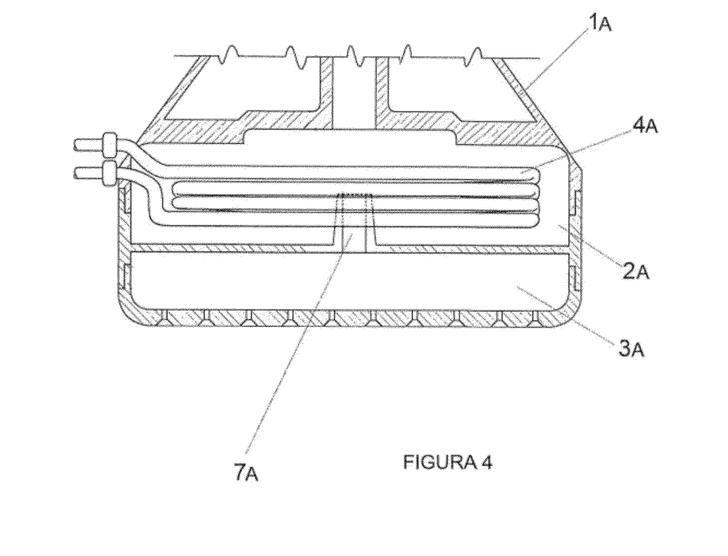

FIG. 3 is a schematic illustration, showing the device inserted into the shower head, connected to the hot/cold water mixer and connected to the cold water input from the water distribution network.

In accordance with these Figures the device placed in a shower head to recover energy used during the bath, in the form of a heat recovery pipe (1), of a material that is a good heat conductor (copper, aluminum, or equivalent), coiled into a spiral form (helix or coil) placed inside the lower output water chamber (2) of the shower head (3), with the ends: input (4) and output (5), emptying into the shell thereof, and connected to the two pipes (6) that are connected to a cold/hot water mixer (7). Said cold/hot water mixer (7), that intercepts the cold water input pipe coming from the public distribution system (8) and is connected to the input pipe (9) of the shower head (3) water.

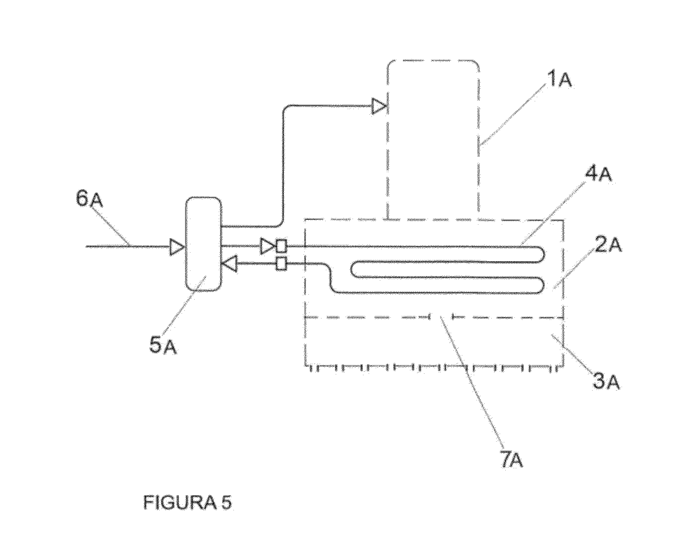

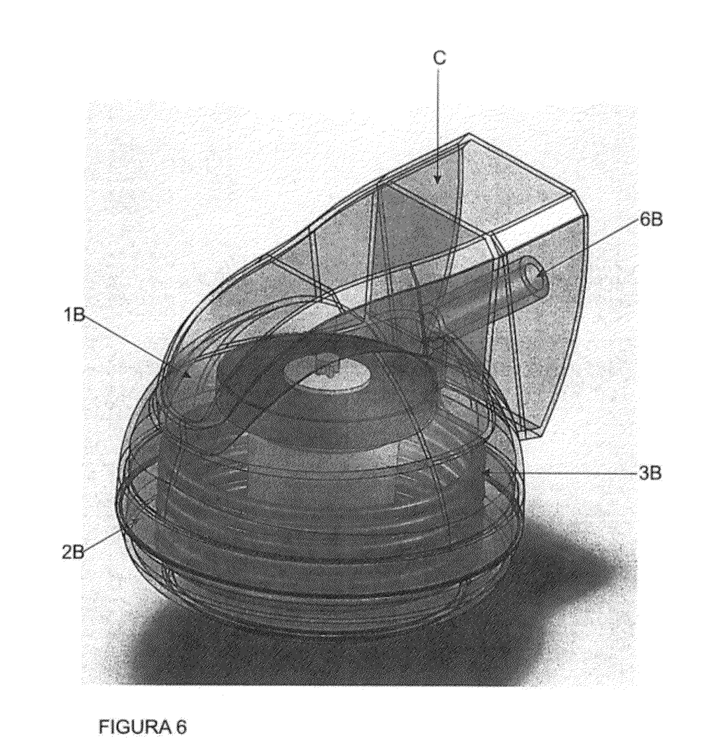

A second embodiment presented in FIGS. 4 and 5 will be described below, where:

FIG. 4 is an top view of a partial crosscut view of a shower head, showing the heat recovery pipe within pre-heating chamber, above the dispersion chamber.

FIG. 5 is a schematic illustration, the device being inserted into the shower head, showing the circuit for the water flow from the water network, which passes through the flow distributor, by the heat recovery pipe within the pre-heating chamber, through the input to the chamber containing the electric heating element and then exits through the dispersion chamber during the bath.

In accordance with this figure and their numbered references, the object of this patent concerns a device introduced into a shower head (1A), to recover energy used during the bath, it provides for a pre-heating chamber (2A), before the water dispersion chamber (3A), where a heat recovery pipe (4A) made from a material that is a good heat conductor (copper, aluminum, or equivalent) which enters it, emptying into the shell of the shower head (1A), coming from a hot/cold water distributor (5A), to form a spiral curve inside that intercepts the intake cold water pipe from the water network (6A).

Said heat recovery tube (4A) that, after forming the spiral curve, of the coil type, inside the pre-heating chamber (2A) returns, emptying into the shell of the shower head (1A), to the hot/cold water distributor (5A). Said pre-heating chamber (2A), below the electric heating element chamber and above the dispersion chamber (3A), that communicates to the dispersion chamber (3A) through an opening (7a) placed axially within a conical pipe that projects from the bottom of the pre-heating chamber (2A).

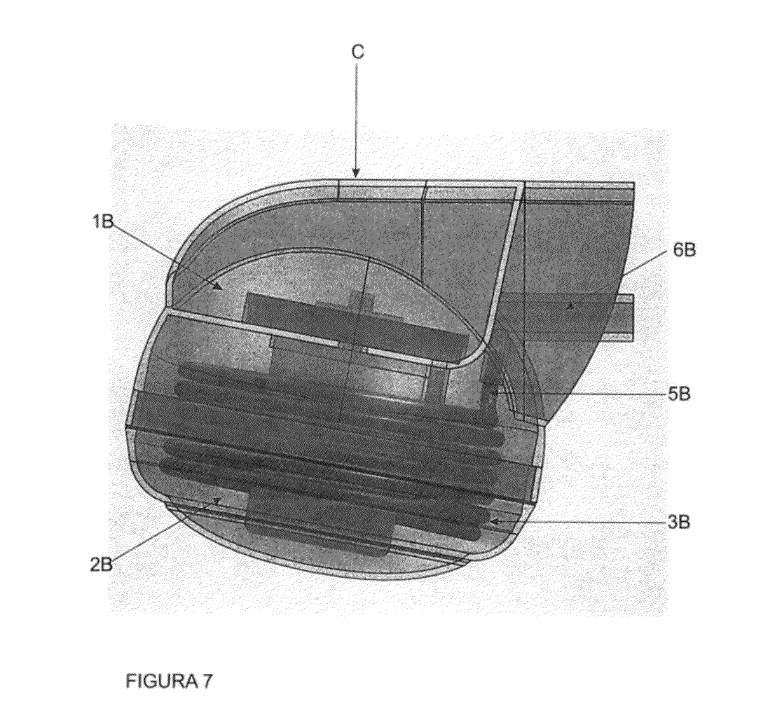

A third embodiment which is considered preferred, is illustrated in FIGS. 6 to 9 will be described in an detailed form below:

Basically, a coiled tube is placed inside the belly of the shower head in order to capture heat energy generated through water heated by a heating element, returning it to the cold water input, significantly increasing the efficiency of the system.

This new constructive device, when applied to electric shower heads presents an energy efficiency that has to date not been attained and, for the purpose of illustration, the experiments carried out show the following results:

| Common Shower Head | Shower Head with the Proposed |
|---|---|
| 4,500 Watts of Resistance | 2,200 Watts of Resistance |
| Amperage Used—37.0 | Amperage Used—17.8 |
| Water temperature—36.7° C. | Water temperature—39.6° C. |

In this example, with a reduction of close to 52% of amperage used, the proposed innovation reaches a temperature that is 8% greater. The economy is extremely important and the cost of its implementation extremely low, making it the best cost to benefit to date attained by any system or device known on the market, or even described in patents or other known publications, making it a highly efficient and effective solution for the purpose which it proposes.

For a perfect image of the preferred embodiment, illustrative Figures are attached, wherein:

FIG. 6 is a semi-transparent view in perspective, showing the constructive device inside the shell of a shower head adapted to receive the innovation;

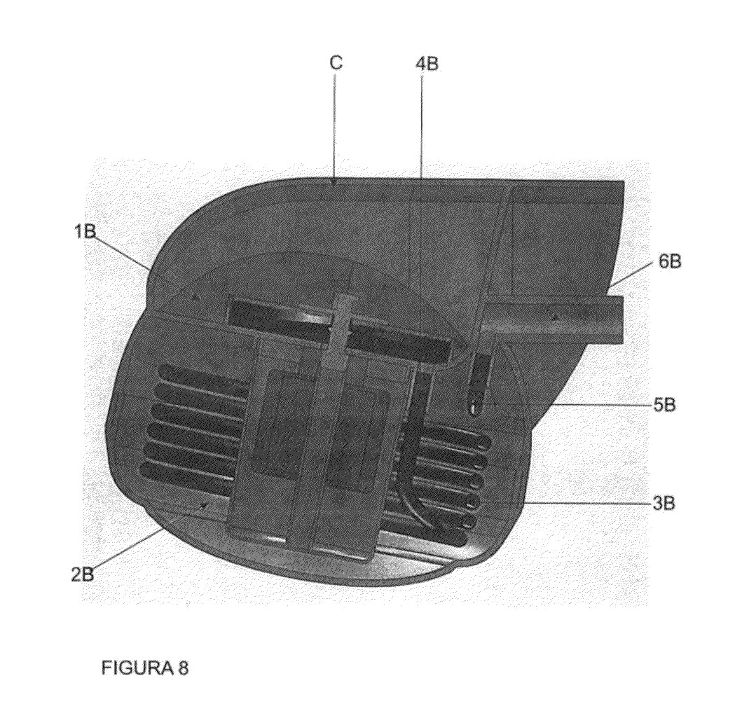

FIG. 7 is a semi-transparent side view, showing the constructive device inside the shell of a shower head adapted to receive the innovation;

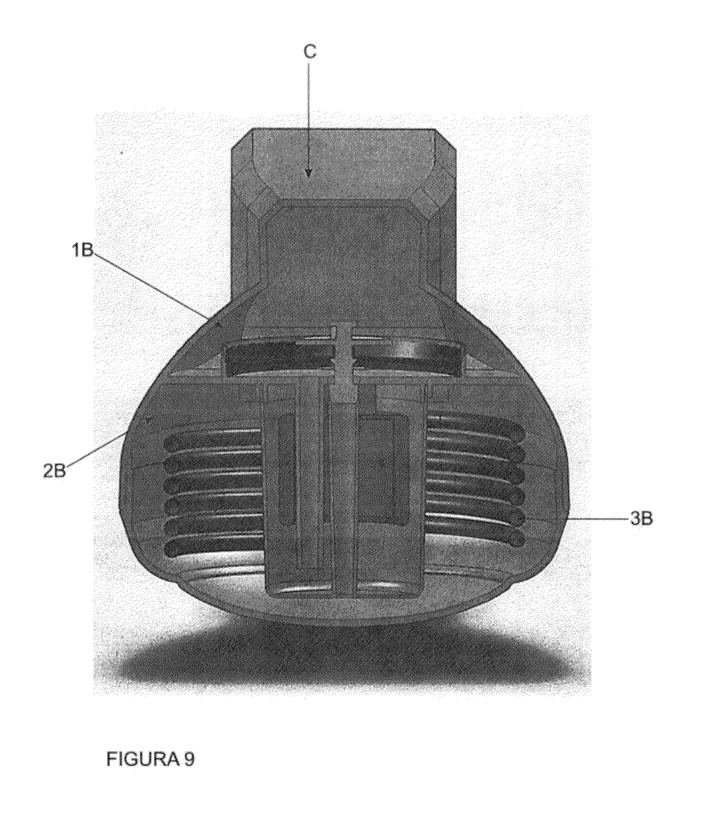

FIG. 8 is a cross-cut side view that illustrates the elements that comprise the proposed solution for shower head in general;

FIG. 9 is a cross-cut side view that illustrates the elements that comprise the proposed solution for shower head in general;

In accordance with the abovementioned Figures: the preferred embodiment possesses an external shell (C), especially designed to cover all the traditional components of a common shower head; an upper chamber (1B) to receive the water from the network and where the heating element is located that will heat it; a lower reheating chamber (2B) which contains a heat recovery pipe (3B) inside; made of a material that is a good heat conductor (copper, aluminum, or equivalent), coiled into a spiral form (helix or coil) placed inside said chamber (2B), said pipe (3B) having one end (4B) as an input coming from the upper chamber (1B) and an output (5B) connected to an input pipe (6B) for the cold water coming from the network.

In practice, when the shower head is connected, the cold water coming from the distribution network penetrates inside the chamber (1B), the electric heating element heats the water that then descends from the chamber (2B), normally exiting through the lower part of the shell (C).

Upon passing through the lower reheating chamber (2B), the water comes into contact with the pipe (3B) that receives the heat of the water coming from the chamber (1B) and returns it heated to the cold water input pipe (6B) through the exit (5B). In this way, a circuit is created, where the upon entering the water in contact with the electric heating element which is already pre-heated, minimizing the amount of energy necessary to raise the water to the ideal temperature for the user. This same water recirculation principal may be used in other equipment, such as steam boilers or industrial equipment and machines that use heated water in their processes, and is applicable in industrial cooking, laundries, etc.

1. “SHOWER HEAD DEVICE TO RECOVER ENERGY USED DURING THE BATH” earmarked for the industry dedicated to electric equipment like shower heads, faucets, boilers, and equipment that uses hot water, characterized in that it consists of a heat recovery pipe (1), made of a material that is a good heat conductor (copper, aluminum, or equivalent), coiled into a spiral form (helix or coil) placed inside the lower water output chamber (2), of the shower head (3), with input (4) and output (5) on its ends, emptying into the shell of the shower head (3) and connected to two pipes (6) that are connected to a cold/hot water mixer (7); said cold/hot water mixer (7), that intercepts the cold water input pipe coming from the public distribution system (9) and is connected to the input pipe (8) of the shower head (3) water.

2. “SHOWER HEAD DEVICE TO RECOVER ENERGY USED DURING THE BATH” in accordance with claim 1, characterized in that it is a constructive variation of a device to be placed in a shower head (1) to recover energy consumed in heating of the water of a shower head (1) that contains a heat recovery pipe (4), made of a material that is a good heat conductor (copper, aluminum, or equivalent), fed by the hydraulic water input (6), through a flow distributor, characterized in that it comprises a heat recovery pipe (4), contained in a pre-heating chamber (2) placed immediately below the electric heating element chamber and above the water dispersion chamber (3); with the two chambers (2 and 3) communicating through an opening (7) placed axially in a conical pipe that projects from the bottom of the pre-heating chamber (2).

3. “SHOWER HEAD DEVICE TO RECOVER ENERGY USED DURING THE BATH” in accordance with claim 1, characterized in that it is a constructive variation and allows recirculation of the water inside the belly or shell of the shower head or similar equipment, basically comprising a pipe in the form of a coil placed inside the belly of the shower head or similar equipment, so as to capture heat energy generated through water heated by an element, returning it to the cold water input.

4. “SHOWER HEAD DEVICE TO RECOVER ENERGY USED DURING THE BATH” in accordance with claim 3, characterized in that the preferred embodiment is basically constituted of an external shell (C) especially designed to fit all traditional components of a common shower head, an upper chamber (1B) to receive the water from the network and where the heating element is located that will heat it, a lower reheating chamber (2B) that contains a heat recovery pipe (3B) inside, coiled into a spiral form (helix or coil) placed inside said chamber (2B), said pipe (3B) having one end (4B) as an input coming from the upper chamber (1B) and an output (5B) connected to an input pipe (6B) for the cold water coming from the network.
